(19) United States
(12) Patent Application Publication
(10) Pub. No.: US 2018/0330429 A1
(43) Pub. Date: Nov. 15, 2018

(54) Leading Edge Detection, Rotation, and Occlusion of Space Between Neighboring Image Pairs of a Set of Images

(71) Applicant: Google Inc., Mountain View, CA (US)

(72) Inventors: Yuli Gao, Sunnyvale, CA (US); Zhengdong Zhang, Cambridge, MA (US)

(21) Appl. No.: 14/173,785

(22) Filed: Feb. 5, 2014

(51) Int. Cl. G06Q 30/06

(52) U.S. Cl. CPC G06Q 30/0643; G06Q 30/0631

(57) ABSTRACT

A user accesses a recommendation website and selects an item from the website. A recommendation application searches for associated items, selects a set of items, and transmits the set to the layout application. A layout application identifies the images by category, creates a virtual presentation space, and positions the images within component sections of the virtual presentation space. The layout application modifies the position of, proportionally resizes, and rotates the component sections based on categorical constraints. To rotate each component section, neighboring component sections are detected, the component sections are grouped, the leading edges are detected between images, the neighboring component sections are positioned so that leading edges of the images are parallel, overlapping empty space is occluded, and the component section pair is jointly rotated. The virtual presentation space is scored and subsequent virtual presentation spaces are created. The best-scored virtual presentation space is displayed on the website.

### TECHNICAL FIELD

The present disclosure relates generally to generating presentations of images, and more particularly to creating presentations of images by arranging and rotating the images within a virtual presentation space and scoring the presentations according to conformity with categorical rules.

### BACKGROUND

When a user selects an item for purchase from an online merchant via a user device, a recommendation engine may show a set of recommended items based on the user selection. Advertisers may desire that the images of the recommended items be displayed in a visually appealing manner, for example, in a collage format.

Conventional technology does not provide for the detection of leading edges of objects within images and the alignment of the leading edges through rotation according to categorical rules.

### SUMMARY

In certain example aspects described herein, a computer-implemented method to create and display a virtual presentation space comprising recommended items in response to a user selection is provided. The user accesses a recommendation website and the user selects an item from the website. The recommendation application searches for associated items, selects a set of items, and transmits the set of items to the layout application, which receives the set of items. The layout application identifies the images by category, creates a virtual presentation space, and positions the images within component sections of the virtual presentation space. The layout application modifies the position of the component sections based on categorical constraints. The layout application proportionally resizes the component sections based on categorical constraints.

The layout application rotates the component sections: each component section comprising an image is selected, neighboring component sections comprising images are detected, the component section is grouped with the neighboring component section, the leading edges are detected between images in the neighboring component sections, the neighboring component sections are positioned so that leading edges of the images within the component sections are parallel, overlapping empty space is occluded, and the component section pair is jointly rotated based on categorical rules. The virtual presentation space is scored based on conformity with categorical constraints and subsequent virtual presentation spaces are created, scored, and stored. The virtual presentation space with the best score is displayed on the website for the user.

In certain other example aspects described herein, a system and a computer program product to create and display a virtual presentation space comprising recommended items in response to a user selection are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for creating and displaying a virtual presentation space of recommended images based on a user search, in accordance with certain example embodiments.

FIG. 2 is a block flow diagram depicting a method for creating and displaying a virtual presentation space of recommended images based on a user search, in accordance with certain example embodiments.

FIG. 3 is a block flow diagram depicting a method for creating and scoring virtual presentation spaces based on categorical and space-conservation constraints, in accordance with certain example embodiments.

FIG. 4 is a block flow diagram depicting a method for rotating images to align leading edges, in accordance with certain example embodiments.

FIG. 5 is an illustration of an example virtual presentation space comprising two example component sections, in accordance with certain example embodiments.

FIG. 6 is an illustration of an example virtual presentation space comprising two example component sections, one of which is rotated to align the leading edges of the images within the example component sections, in accordance with certain example embodiments

FIG. 7 is an illustration of an example virtual presentation space comprising two example component sections, one of which is brought into proximity of the other to occlude space between the images within the example component sections, in accordance with certain example embodiments.

FIG. 8 is an illustration of an example virtual presentation space comprising two example component sections that are grouped and jointly rotated according to a categorical rule, in accordance with certain example embodiments.

FIG. 9 is a block diagram depicting a computing machine and module, in accordance with certain example embodiments.

### DETAILED DESCRIPTION OF EXAMPLE EMBODIMENTS

### Overview

The example embodiments described herein provide methods and systems for pre-authorizing an online merchant to conduct transactions. The example embodiments described herein provide computer-implemented techniques for creating and displaying a collage of recommended items based on a user search. For example, a collage of recommended items could be made more visually appealing by presenting the recommended item images in the collage such that the position of the item images are determined according to categorical rules. Particularly in apparel recommendations, a collage of recommended items appears more attractive and coherent if, for example, an image of shoes is positioned below an image of pants.

A layout application receives a set of images from a recommendation application and categorizes the images. The layout application places the images within component sections of a virtual presentation space and alters the positioning and sizing of the component sections according to rules based at least in part on the categorization of the images. The layout application detects any leading edges of images within pairs of neighboring component sections. A leading edge, for example, is a line segment comprising the perimeter of an image or a line segment that passes through multiple points of the perimeter of an image. If the leading edges of images within neighboring component sections are not parallel, the sections are rotated until the leading edges of the images within the component sections are parallel, in conformance to categorical rules. The pair of component sections are rotated together until a desired orientation is reached. Categorical rules may be considered in determining how the grouped component sections should be aligned. Any overlapping space of the component sections is occluded. For example, overlapping space is a section of the virtual presentation space that is occupied by more than one component section. The layout application stores the virtual presentation space comprising the set of images and scores the stored virtual presentation space based on conformity to the categorical rules. The process is repeated and the stored virtual presentation space that conforms most to the categorical rules is selected for presentation to the user.

In an example embodiment, the user accesses a recommendation system website. The user begins a web browsing session on a user device and enters the recommendation system website address. The user may also access the website through opening an application on the user device which communicates with the recommendation system. In this example, the recommendation system distributes the application for download to the user device. In an example embodiment, the recommendation website is a shopping website.

The user selects an item from the website. In an example embodiment, the user selects a category on the recommendation system website, finds an item under that category, and then selects the item using the user interface on the user device. In another example embodiment, the user conducts a keyword search on the recommendation system website and chooses an item from the listed results using the user interface on the user device. For example, the user desires to buy a hat from the recommendation website, conducts a keyword search for “ladies' fancy purple hat,” views several options of hat from which to choose, and selects the desired hat by indicating the preferred hat on the user interface.

The recommendation application searches for associated items. In an example embodiment, all possible items are given ratings and graphed in a virtual recommendation space based on these ratings. In this example embodiment, the recommendation application searches in the virtual recommendation space for the associated items that are the closest to the item selected by the user.

The recommendation application selects a set of items. In an example embodiment, the recommendation application selects a predetermined number of items. For example, the recommendation application selects five items. In another example embodiment, the recommendation application selects a predetermined set of items based on item type. For example, the user selects a ladies' hat, and the recommendation application finds and selects a set of associated items comprising one skirt, one blouse, one pair of gloves, one pair of shoes, one pocketbook, and one decorative walking cane. The recommendation application transmits a set of images to the layout application. The set of images correspond to the selected set of items.

The layout application receives the set of images. In an example embodiment, the set of images comprises both the user-selected image and the images selected by the recommendation application. In an example embodiment, the layout application identifies the images by category. For example, the layout application receives a set of images and uses a shape-recognizing algorithm to determine to which category the image belongs. For example, the layout application receives the set of images selected by the recommendation application in response to the user selection and identifies the images as comprising a skirt, a blouse, a pair of gloves, a pair of shoes, a pocketbook, and a walking cane. In another example, the layout application identifies features of the image comprising color, pattern, gradients, size, and/or shape in order to identify the image by category. For example, the layout application identifies the hat within the image as a formal hat based on the shape, pattern, and color of the image of the hat.

The layout application creates a virtual presentation space. In an example embodiment, this virtual presentation space is a space wherein images are placed and can be displayed to the user via the user interface of a user computing device. The layout application positions item images within component sections of the virtual presentation. In an example embodiment, the layout application uses a block recursive image composition algorithm to divide the virtual presentation space into component sections and place the images within the component sections. In an example embodiment, empty space may exist within each component section that the image does not occupy.

The layout application modifies the position of the component sections based on categorical constraints. Categorical constraints may prescribe relative positions, absolute positions, and/or orientations of the component sections comprising the images in the virtual space. For example, for a component section comprising the image of a hat, there may be an absolute constraint to position the component section comprising the hat at the top of the virtual space and a relative constraint to position the component section comprising the image of the hat above any shirt or dress. In this same example, there may exist a constraint to orient the component section comprising the image of the hat with the brim aligned with the principal horizontal axis of the virtual presentation space or within a certain degree range clockwise or counterclockwise from this axis. The layout application proportionally resizes the component sections comprising the images within the virtual presentation space based on categorical constraints. For example a categorical constraint may exist that an image of a purse is a certain proportion smaller than an image of a dress within the virtual presentation space. In this example, the image of the dress is smaller than the image of the purse and therefore the component section comprising the image of the purse must be reduced until it complies with the categorical size constraint.

The layout application rotates the component sections. In an example embodiment, a component section comprising an image is selected. Neighboring component sections comprising images are detected. For example, a component section in the virtual presentation space comprising an image of a walking cane is neighboring another component section in the virtual presentation space comprising an image of a pair of pants. The layout application groups the two neighboring component sections.

Any leading edges between the images within the neighboring component sections are detected. A leading edge is a line segment comprising the perimeter of an image or a line segment that passes through multiple points of the perimeter of an image. For example, the image comprising the pants is oriented vertically and the image comprising the walking cane is oriented ten degrees clockwise from the vertical axis. In this example, the edge of the walking cane within the image of the walking cane and the edge of the pants within the image of the pants comprise leading edges. The two neighboring component sections are positioned so that the images within the component sections are positioned with the leading edges parallel. Continuing with the previous example, the component section comprising the image of the walking cane oriented at ten degrees is rotated ten degrees counterclockwise so that the leading edge is in alignment with the leading edge of the image of the pants. In an example embodiment, any overlapping empty space is occluded. For example, part of an image within a first component section occupies a region of space of a neighboring component section wherein there is no image. In this example, this region of space in the neighboring component section is occluded by the image within the first component section and would not be visible to a user when the virtual presentation space is displayed via the user interface of a user device.

The component section pair is jointly rotated based on categorical rules. For example, the neighboring component sections aligned according to the leading edges of the images are rotated as one object in the virtual presentation space. For example, a walking cane with a leading edge ten degrees clockwise from the vertical axis and a pair of pants with a vertical leading edge are placed together with the leading edges parallel along the 80-degree axis. In this example, there is a categorical rule that images of pants be aligned parallel with the principal vertical axis of the virtual presentation space. Therefore, both component sections are rotated as one object until the image of the pants is aligned parallel with the vertical axis. In this same example, the image of the walking cane is finally oriented vertically as a result of the rotation.

If subsequent component sections neighbor the selected component section, the component sections are rotated if leading edges are detected between the images within the pair of component sections. In an example embodiment, each neighboring component section to the selected component section is detected and the component sections are rotated according to the method described herein. For each of the remaining component sections, neighboring component sections are detected and the component sections are rotated if leading edges between the images within neighboring component sections are detected. In an example embodiment, the rotation of the component sections is conducting using the method described herein.

The virtual presentation space is scored based on conformity with categorical constraints. In an example embodiment, not all categorical constraints are satisfied perfectly. For example, a component section comprising an image cannot be resized to satisfy a categorical constraint because there is not enough virtual space to do so. In another example, two component sections comprising images are absolutely constrained to be located at the top of the virtual presentation space but one of the two component sections must be placed under or beside the other. In example embodiment, the categorical constraints comprise that the maximum amount of virtual presentation space be conserved. In an example embodiment, the virtual presentation space is scored with a numerical value. The virtual presentation space and the score are stored.

In an example embodiment, subsequent virtual presentation spaces are created, scored, and stored according to the aforementioned method. In an example embodiment, subsequent virtual presentation spaces are created and scored until a desired score is reached. In another example embodiment, a predetermined number of virtual presentation spaces are created, scored, and stored. The virtual presentation space with the best score is displayed on the website for the user, which views the virtual presentation via the user interface of a user computing device. In an example embodiment, the user may select an item image within the virtual presentation space. If the user selects an item image within the virtual presentation space, the recommendation application and layout application find recommended items and display the items in a virtual presentation space format according to the method described herein.

### Example System Architecture

Turning now to the drawings, in which like numerals indicate like (but not necessarily identical) elements throughout the figures, example embodiments are described in detail.

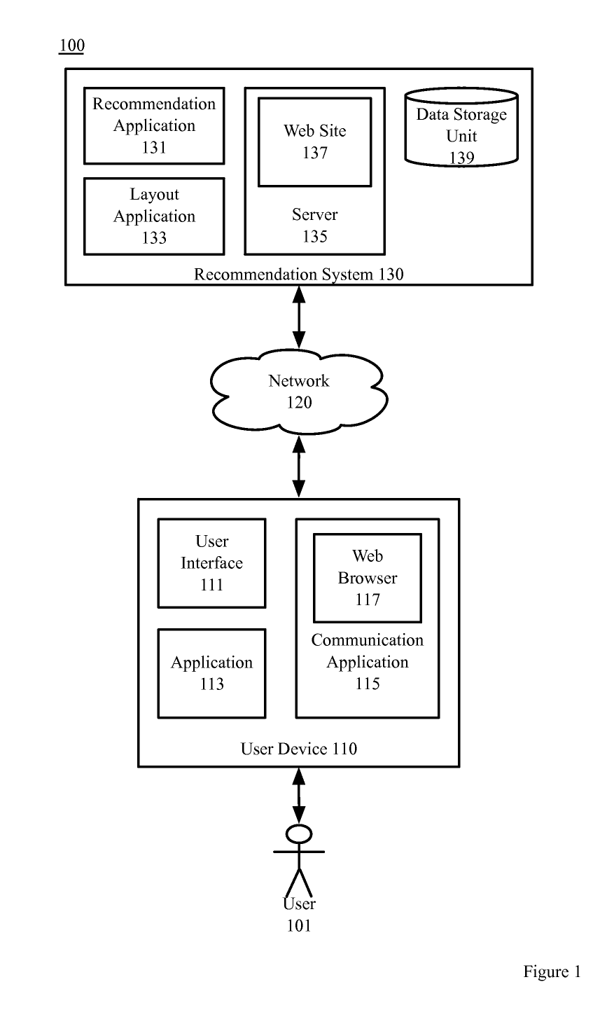

FIG. 1 is a block diagram depicting a system 100 for creating and displaying a virtual presentation space of recommended images based on a user search, in accordance with certain example embodiments. As depicted in FIG. 1, the system 100 includes network computing devices 110 and 130 that are configured to communicate with one another via one or more networks 120. In some embodiments, a user associated with a device must install an application and/or make a feature selection to obtain the benefits of the techniques described herein.

For example, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110 and 130 includes a device having a communication module capable of transmitting and receiving data over the network 120. For example, each network computing device 110 and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110 and 130 are operated by users 101 and recommendation system operators, respectively.

An example user computing device 110 comprises a user interface 111, an application 113, a communication application 115, and a web browser 117. In an example embodiment, the user interface 111 enables the user 101 to interact with the application 113 and/or the web browser 117. For example, the user interface 111 may be a touch screen, a voice-based interface or any other interface that allows the user 101 to provide input and receive output from an application or module on the user computing device 110.

In an example embodiment, the user 101 can use a communication application 115, such as a web browser 117 application or a stand-alone application 113, to view, download, upload, or otherwise access documents or web pages via a distributed network 120.

In an example embodiment, the application 113 is a program, function, routine, applet, or similar entity that exists on and performs its operations on the user computing device 110. In certain embodiments, the user 101 must install the application 113 and/or make a feature selection on the user computing device 110 to obtain the benefits of the techniques described herein. In an example embodiment, the user 101 may access the application 113 on the user computing device 110 via a user interface 111. In an example embodiment, the application 113 enables the user 101 select an item and receive a set of recommended items from the recommendation system 130 over the network 120.

In an example embodiment, the communication application 115 can interact with web servers or other computing devices connected to the network 120, including the user computing device 110 and the web server 135 of the payment recommendation system 130.

In an example embodiment, the web browser 117 can enable the user 101 to interact with web pages using the user computing device 110. In an example embodiment, the web browser 117 enables the user 101 to view the recommendation system's 130 web site 137 and to navigate the web site 137 to select products.

An example recommendation system 120 comprises a recommendation application 131, a layout application 133, a server 135, a web site 137, and a data storage unit 139.

In an example embodiment, the recommendation application 131 communicates with the layout application 133, the web site 137, and the data storage unit 139. In an example embodiment, the recommendation application 131 receives an item selected by the user 101 on the web site 137 and compiles a set of recommended items that correspond to the user 101 selected item. In an example embodiment, the recommendation application 131 accesses the data storage unit 139 to find and compile the set of recommended items. In an example embodiment, the recommendation application 131 transmits the set of recommended items to the layout application 133, which creates a virtual presentation of the set of items.

In an example embodiment, the layout application 133 communicates with the recommendation application 131, the web site 137, and the data storage unit 139. In an example embodiment, the layout application 133 receives a set of recommended items from the recommendation application 131. In an example embodiment, the layout application 133 takes this set of recommended items and arranges them in a virtual presentation space and saves the virtual presentation space in the data storage unit 139. In an example embodiment, the layout application 133 creates several virtual presentation spaces, determines a score based on compliance with categorical rules, and saves the virtual presentation spaces in the data storage unit 139. In an example embodiment, the layout application 133 selects, from the data storage unit 139, the virtual presentation space with the best score and transmits it to the web site 137 for display to the user 101 over the network 120.

In an example embodiment, the web server 135 provides the content that the user 101 accesses through the application 113 and/or the web browser 117 on the user computing device 110, including but not limited to html documents, images, style sheets, and scripts. In an example embodiment, the web server 121 supports the recommendation system's 120 web site 137 which enables the user 101 to select an item and receive a set of recommended items arranged in a virtual presentation space.

In an example embodiment, the recommendation system 130 web site 137 communicates with the recommendation application 131, the layout application 133, the server 135, and the data storage unit 139. In an example embodiment, the web site 137 displays items for the user 101 to view and select via the communication application 112 web browser 114 of the user computing device 110 and transmits the user 101 selection to the recommendation application 131, which compiles a set of recommended items. In an example embodiment, the web site 137 displays a virtual presentation space from the data storage unit 139 selected by the layout application 133 to display to the user 101 over the network 120. In an example embodiment, the web site 137 is supported by the merchant server 135.

It will be appreciated that the network connections shown are example and other means of establishing a communications link between the computers and devices can be used. Moreover, those having ordinary skill in the art having the benefit of the present disclosure will appreciate that the user computing device 110 and the recommendation system 130 illustrated in FIG. 1 can have any of several other suitable computer system configurations. For example, a user computing device 110 embodied as a mobile phone or handheld computer may or may not include all the components described above.

### Example Processes

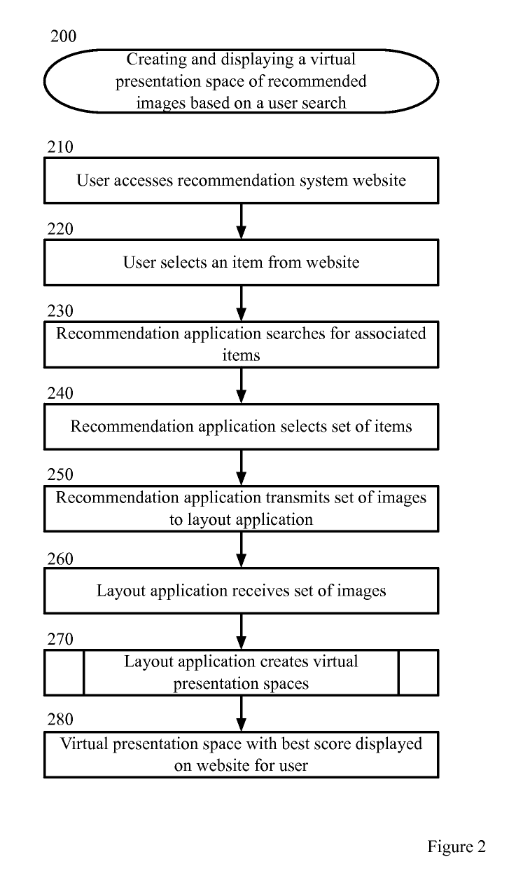

The example methods illustrated in FIGS. 2-4 are described hereinafter with respect to the components of the example operating environment 100. The example methods of FIGS. 2-4 may also be performed with other systems and in other environments.

FIG. 2 is a block diagram depicting a method 200 for creating and displaying a virtual presentation space of recommended images based on a user search, in accordance with certain example embodiments. The method 200 is described with reference to the components illustrated in FIG. 1.

In block 210, the user 101 accesses the recommendation system 130 website 137. In an example embodiment, the user 101 begins a web browsing session on a user device 110 and enters the recommendation system 130 website 137 address. In another example embodiment, the user 101 accesses the website 137 through opening an application 113 on the user device 110 which communicates with the recommendation system 130 over the network 120. In this example, the recommendation system 130 distributes the application 113 for download to the user device 110. In an example embodiment, the recommendation website 137 is a shopping website.

In block 220, the user 101 selects an item from the website 137. In an example embodiment, the user 101 selects a category on the recommendation system 130 website 137, finds an item under that category, and then selects the item using the user interface 111 on the user device 110. For example, the user 101 desires to buy a hat from the recommendation website 137, actuates a user interface 110 object to select the category “hats”, then browses the hat-related items under that category to select a hat. In another example embodiment, the user 101 conducts a keyword search on the recommendation system 130 website 137 and chooses an item from the listed results using the user interface on the user device. For example, the user 101 desires to buy a hat from the recommendation website 137, conducts a keyword search for “ladies' fancy purple hat”, views several options of hat from which to choose, and selects the desired hat by indicating the preferred hat on the user interface 110.

In block 230, the recommendation application 131 searches for associated items. In an example embodiment, all possible items are given ratings and graphed in a virtual recommendation space based on these ratings. In this example embodiment, the recommendation application 131 searches in the virtual recommendation space for the associated items that are the closest to the item selected by the user 101. In an example embodiment, the searchable items are graphed using an embedding approach such that every item has a specific coordinate in the virtual recommendation space that is correlated with characteristics of the item over dimensions of evaluation.

In block 240, the recommendation application 131 selects a set of items. In an example embodiment, the recommendation application 131 selects a predetermined number of items. For example, the recommendation application 131 selects five related items regardless of the item that the user 101 selects. In another example embodiment, the recommendation application 131 selects a predetermined set of items based on item type. For example, the user 101 selects a ladies' hat, and the recommendation application 131 finds and selects a set of associated items comprising one skirt, one blouse, one pair of gloves, one pair of shoes, one pocketbook, and one decorative walking cane.

In block 250, the recommendation application 131 transmits a set of images to a layout application 133. In an example embodiment, the set of images correspond to and are representations of the selected set of items.

In block 260, the layout application 133 receives the set of images. In an example embodiment, the set of images comprises both the image selected by the user 101 and the images selected by the recommendation application 131.

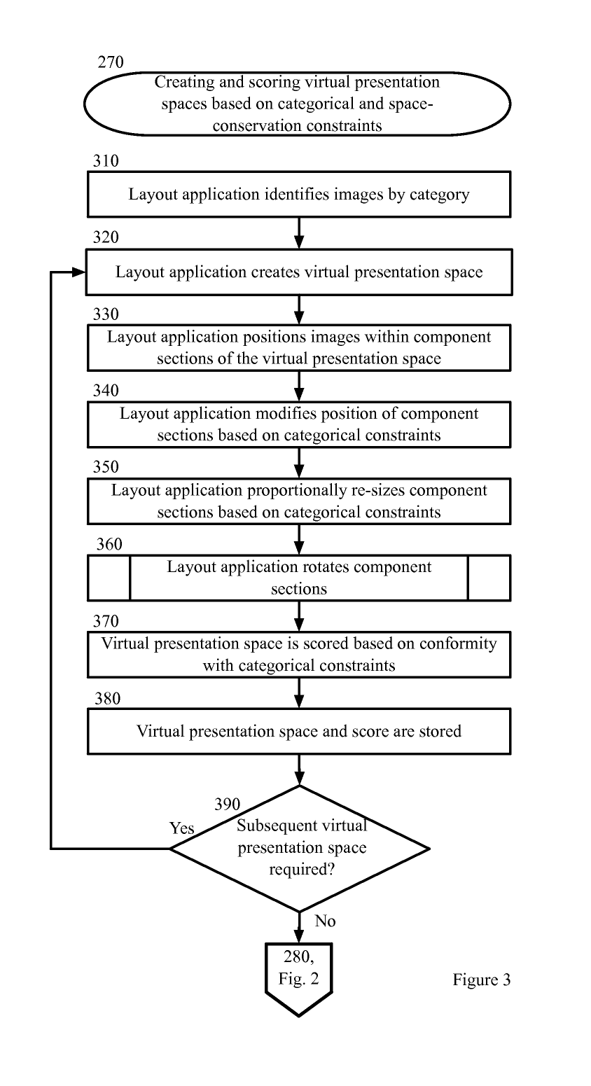

In block 270, the layout application 133 creates virtual presentation spaces. In an example embodiment, a virtual presentation space is a virtual space wherein images are placed and can be displayed to the user 101 via the user interface 111 of a user computing device 110. The method 270 for creating the virtual presentation spaces is described in more detail hereinafter with reference to the methods described in FIG. 3.

FIG. 3 is a block diagram depicting a method 270 for creating and scoring virtual presentation spaces based on categorical and space-conservation constraints, in accordance with certain example embodiments. The method 270 is described with reference to the components illustrated in FIG. 1.

In block 310, the layout application 133 identifies images by category. For example, the layout application 133 receives a set of images and uses a shape-recognizing algorithm to determine to which category the image belongs. For example, the layout application 133 receives the set of images selected by the recommendation application 131 in response to the user 101 selection and identifies the images as comprising a skirt, a blouse, a pair of gloves, a pair of shoes, a pocketbook, and a walking cane. In another example, the layout application 133 identifies features of the image comprising color, pattern, gradients, size, and/or shape in order to identify the image by category. For example, the layout application identifies the hat within the image as a formal hat based on the shape, pattern, and color of the image of the hat.

In block 320, the layout application 133 creates a virtual presentation space. In an example embodiment, this virtual presentation space is a virtual space wherein images are placed and can be displayed to the user 101 via the user interface 111 of a user computing device 110.

In block 330, the layout application 133 positions the images within component sections of the virtual presentation space. In an example embodiment, the virtual space is divided into rectangular component sections. In another example embodiment, the virtual presentation space is divided into component sections comprising any combination of one or more shapes or forms. In an example embodiment, the layout application 133 uses a block recursive image composition algorithm to divide the virtual presentation space into rectangular component sections and place the images within the rectangular component sections. In an example embodiment, empty space may exist within each component section that the image does not occupy.

In block 340, the layout application 133 modifies the position of the component sections based on categorical constraints. In an example embodiment, categorical constraints prescribe relative positions, absolute positions, and/or orientations of the component sections comprising the images in the virtual space. For example, in a virtual apparel presentation, for a component section comprising the image of a hat, there may be an absolute constraint that the component section comprising the hat be positioned at the top of the virtual space and a relative constraint that the component section comprising the image of the hat be positioned above any shirt or dress. In this same example, there may be a constraint that the component section comprising the image of the hat be oriented so that the brim of the hat is aligned with the principal horizontal axis of the virtual presentation space or within a certain degree range clockwise or counterclockwise from this axis.

In block 350, the layout application 133 proportionally resizes the component sections based on categorical constraints. For example, for a virtual apparel presentation, there is a categorical constraint that an image of a purse be a certain proportion smaller than an image of a dress within the virtual presentation space. In this example, the image of the dress is smaller than the image of the purse and therefore the component section comprising the image of the purse must be enlarged until it complies with the categorical size constraint. In an example embodiment, the layout application 113 positions the component sections of the virtual space, modifies the position of the component sections, and proportionally resizes the component sections to create a virtual space comprising all of the component sections.

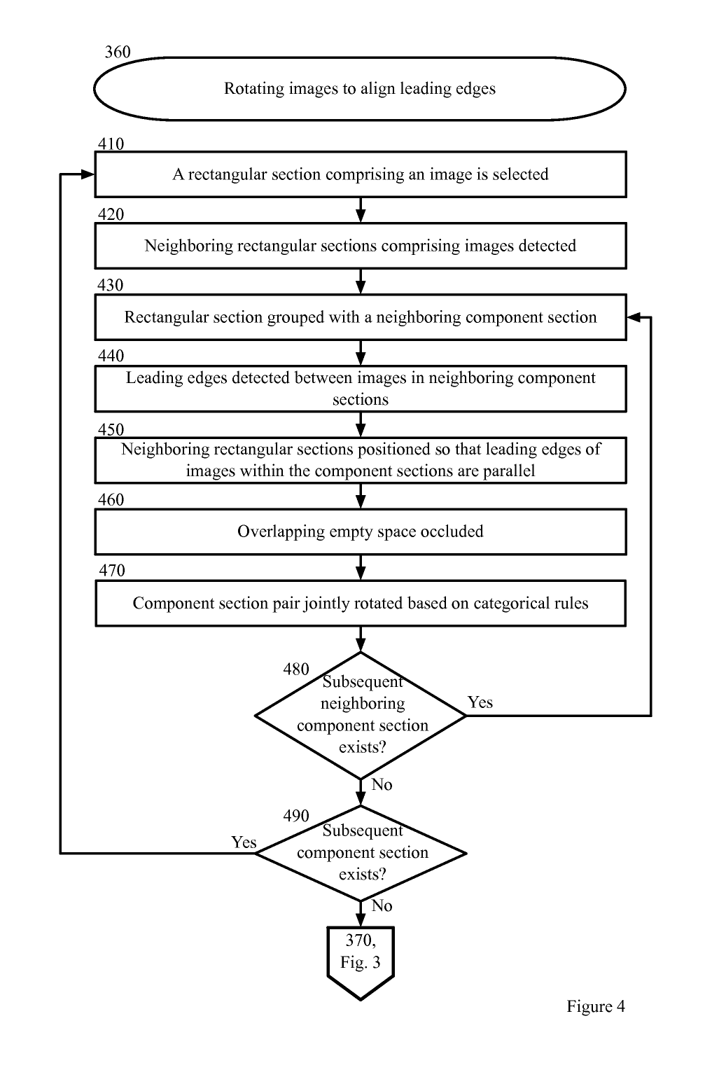

In block 360, the layout application 133 rotates the component sections. The method 360 for rotating the component sections is described in more detail hereinafter with reference to the methods described in FIG. 4.

FIG. 4 is a block diagram depicting a method 360 for rotating images to align leading edges, in accordance with certain example embodiments. The method 360 is described with reference to the components illustrated in FIG. 1.

In block 410, a component section comprising an image is selected. In an example embodiment, a certain component section comprising an image is selected. For example, a virtual presentation space comprises five component sections comprising images from the set of images received by the layout application 133 from the recommendation application 131. In this same example, the layout application 133 selects the component section comprising the first image in the set of images received from the recommendation application 131. In another example embodiment, a component section comprising an image is selected randomly.

In block 420, neighboring component sections comprising images are detected. In an example embodiment, the layout application 133 analyzes the selected component section for adjacent component sections comprising images. For example, a component section in the virtual presentation space comprising an image of a walking cane is neighboring another component section in the virtual presentation space comprising an image of a pair of pants. The layout application groups the two neighboring component sections.

In block 430, a component section is grouped with a neighboring component section. For example, the layout application 133 focuses on the group of two neighboring component sections to complete several processing steps. The component sections may each be paired with a neighbor until all component sections are paired. The grouping step and the related processing of component section pairs may be repeated multiple times as the virtual presentation space is processed.

In block 440, leading edges are detected between images in the neighboring component sections. A leading edge is a line segment comprising the perimeter of an image or a line segment that passes through multiple points of the perimeter of an image. For example, in a virtual apparel presentation, an image comprising pants is oriented vertically and the image comprising a walking cane is oriented ten degrees clockwise from the vertical axis. In this example, the edge of the walking cane within the image of the walking cane and the edge of the pants within the image of the pants comprise leading edges. In an example embodiment, an image detection algorithm can be used to detect leading edges between images within neighboring component sections of the virtual space.

In block 450, the neighboring component sections are positioned so that the leading edges of the images within the component sections are parallel. Continuing with the previous example, the component section comprising the image of the walking cane oriented at ten degrees is rotated ten degrees counterclockwise so that the leading edge is in alignment with the leading edge of the image of the pants in the adjacent component section.

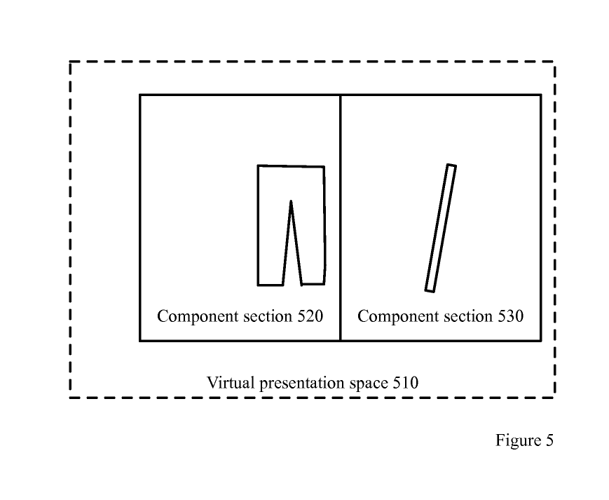

FIG. 5 is an illustration of a sample virtual presentation space 510 divided into two example rectangular component sections 520 and 530, in accordance with certain example embodiments. In this illustration, an image of pants within the component section 520 has a vertical leading edge whereas an image of a cane within the component section 520 has a leading edge that is ten degrees clockwise from vertical.

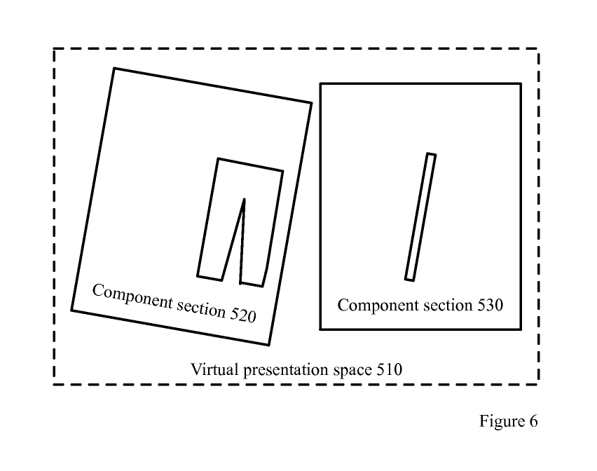

FIG. 6 is an illustration of a sample virtual presentation space 510, continuing with the previous illustration shown in FIG. 5, after a component section 520 is rotated to align the leading edge of the image within the component section 520 with the leading edge of the image within neighboring component section 530 so that the two leading edges are parallel, in accordance with certain example embodiments. In this same illustration, the component section 520 has been rotated ten degrees clockwise such that the leading edge of the image of the pants within the component section 520 is parallel with the leading edge of the image of the cane within the component section 530 (both are at ten degrees clockwise from vertical orientation).

Returning to FIG. 4, in block 460, overlapping empty space is occluded. For example, part of an image within a first component section occupies a region of space of a neighboring component section wherein an image is not present. In this example, this region of space in the neighboring component section is occluded by the image within the first component section and would not be visible to a user 101 were the virtual presentation space displayed via the user interface 111 of a user device 110. In an example embodiment, to occlude overlapping empty space, the component sections are moved toward one another until a configurable amount of space exists between the images within the component sections.

In block 470, the component section pair is jointly rotated based on categorical rules. For example, the neighboring component sections aligned according to the leading edges of the images are rotated as one object in the virtual presentation space. Continuing with the previous example, a walking cane with a leading edge ten degrees clockwise from the vertical axis and a pair of pants with a vertical leading edge are placed together with the leading edges parallel along the 80-degree axis. In this example, there is a categorical rule to align images of pants parallel with the principal vertical axis of the virtual presentation space—therefore both component sections are rotated as one object until the image of the pants is aligned parallel with the vertical axis. In this same example, the image of the walking cane is finally oriented vertically as a result of the rotation. Continuing with this example, the grouped and aligned component sections are adjacent to a third component section comprising an image of shoes with a leading edge. In this example, there is a categorical rule to align the opening of the shoes parallel with the cuff of the pants. In this example, the third component section comprising the image of the shoes is aligned with the grouped and aligned component sections comprising the images of the pants and cane according to the categorical rule. In this example, the three aligned component sections may be rotated as one object according to any applicable categorical rules.

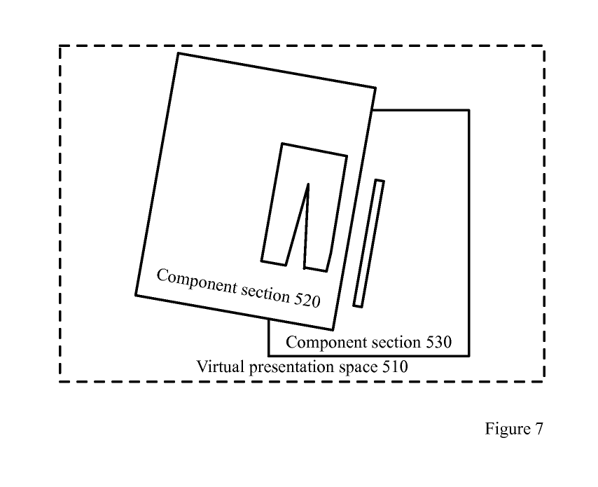

FIG. 7 is an illustration of a sample virtual presentation space 510, continuing with the previous illustration shown in FIG. 6, shown after the component sections 520 and 530 have been aligned along the leading edge and empty space between images within the component sections 520 and 530 has been occluded, in accordance with certain example embodiments.

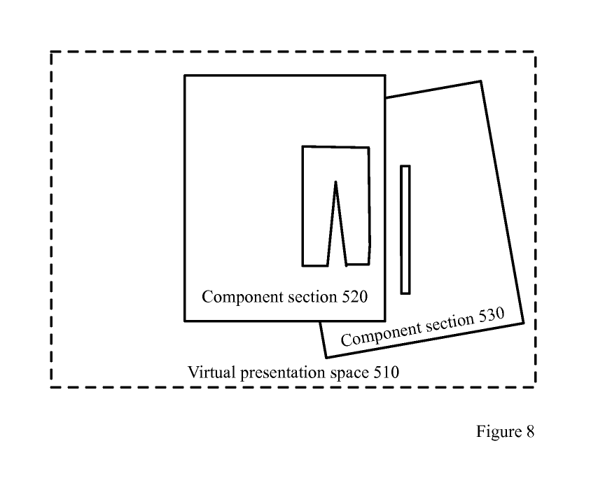

FIG. 8 is an illustration of a sample virtual presentation space 510, continuing with the previous illustration shown in FIG. 7, shown after the component sections 520 and 530 have been jointly rotated to align the combined leading edge to conform with a categorical rule, in accordance with certain example embodiments. In this example illustration, the categorical rule is that the leading edges of pants and a cane be aligned with the principal vertical axis of the virtual presentation space 510.

Returning to FIG. 4, in block 480, the layout application 133 determines whether there is a subsequent neighboring component section to the selected component section.

If the layout application 133 determines that that there is a subsequent neighboring component section to the selected component section, the method 360 proceeds to block 430 in FIG. 4. In an example embodiment, the selected component section is grouped with the subsequent neighboring component section, the leading edges are detected between images in the neighboring component sections, the neighboring component sections are positioned so that the leading edges of the images within the component sections are parallel, overlapping empty space is occluded, and the component section pair is jointly rotated based on categorical rules. In an example embodiment, this subsequent neighboring component section is repeated until there are no remaining subsequent neighboring component sections adjacent to the selected component section.

Returning to block 480, if the layout application 133 determines that there is not a neighboring component section to the selected component section, the method 360 proceeds to block 490.

In block 490, the layout application 133 determines whether there is a subsequent component section.

If the layout application 133 determines that there is a subsequent component section, the method 360 proceeds to block 410 in FIG. 4. For example, the layout application 133 previously selected the component section comprising the first image of a set of five item images received from the recommendation system 131. Continuing with this same example, the layout application 133 selects the component section comprising the second image of the set.

Returning to block 490, if the layout application 133 determines that there is a not a subsequent component section, the method 360 proceeds to block 370 in FIG. 3.

Returning to FIG. 3, in block 370, the virtual presentation space is scored based on conformity with categorical constraints. In an example embodiment, not all categorical constraints are satisfied perfectly. For example, a component section comprising an image cannot be resized to satisfy a categorical constraint because there is not enough space. In another example, two component sections comprising images are absolutely constrained to be located at the top of the virtual presentation space but one of the two component sections must be placed under or beside the other. In an example embodiment, the categorical constraints comprise that the maximum amount of virtual presentation space be conserved.

In an example embodiment, the virtual presentation space score can be calculated based on a percentage of the total number of applicable categorical constraints met by the virtual presentation space. In another example embodiment, the virtual presentation space score can be the sum of the number of applicable categorical constraints obeyed by the virtual presentation space. In some example embodiments, certain categorical constraints are more important than others and have a greater impact than other categorical constraints on the virtual presentation space score. For example, when the position, size, or rotation of a component section make it impossible to conform to all applicable categorical rules, conformity to a categorical rule mandating an absolute position within the virtual presentation space may have more of an effect on the score than a categorical rule mandating a relative position to an adjacent component section.

In block 380, the virtual presentation space and the score are stored. In an example embodiment, the virtual presentation space is scored with a numerical value. In an example embodiment, the virtual presentation space and score are stored on the data storage unit 139.

In block 390, the layout application 133 determines if a subsequent virtual presentation space is possible or required. In an example embodiment, subsequent virtual presentation spaces are created, scored, and stored according to the aforementioned method. In an example embodiment, subsequent virtual presentation spaces are created and scored until a desired score is reached. In another example embodiment, a predetermined number of virtual presentation spaces are created, scored, and stored.

If the layout application 133 determines that a subsequent virtual presentation space is possible or required, the method 270 proceeds to block 320 in FIG. 3. In an example embodiment, the layout application 133 creates the virtual presentation space, positions images within component sections of the virtual presentation space, modifies the position of and proportionally resizes the component sections based on categorical constraints, rotates the component sections, and scores and stores the virtual presentation space based on conformity with the categorical constraints

Returning to block 390 in FIG. 3, if the layout application 133 determines that a subsequent virtual presentation space is not required, the method 270 proceeds to block 280 in FIG. 2.

Returning to FIG. 2, in block 280, the virtual presentation space with the best score is displayed on the website 137 for the user 101. In an example embodiment, the virtual presentation space with the highest score is displayed on the website 137. In this example embodiment, a virtual presentation space receives a higher score the more it conforms to applicable categorical rules. In another example embodiment, multiple virtual presentation spaces are displayed. For example, the layout application 113 or recommendation system 120 determines a threshold score and multiple virtual presentation spaces may be presented that meet the threshold score. In an example embodiment, the layout application 133 saves the virtual presentation space to the data storage unit 139. In this example embodiment, the web server 135 accesses the data storage unit 139 to retrieve the virtual presentation space or receives the virtual presentation space directly from the layout application 133. In this example embodiment, the website 137 displays the virtual presentation space content from the web server 135 and the user 101 access the website 137 to view the virtual presentation space via the application 113 or the web browser 117 resident on the user computing device 110. In this example embodiment, the virtual presentation space is displayed on the user interface 111 of the user computing device 110.

### Other Example Embodiments

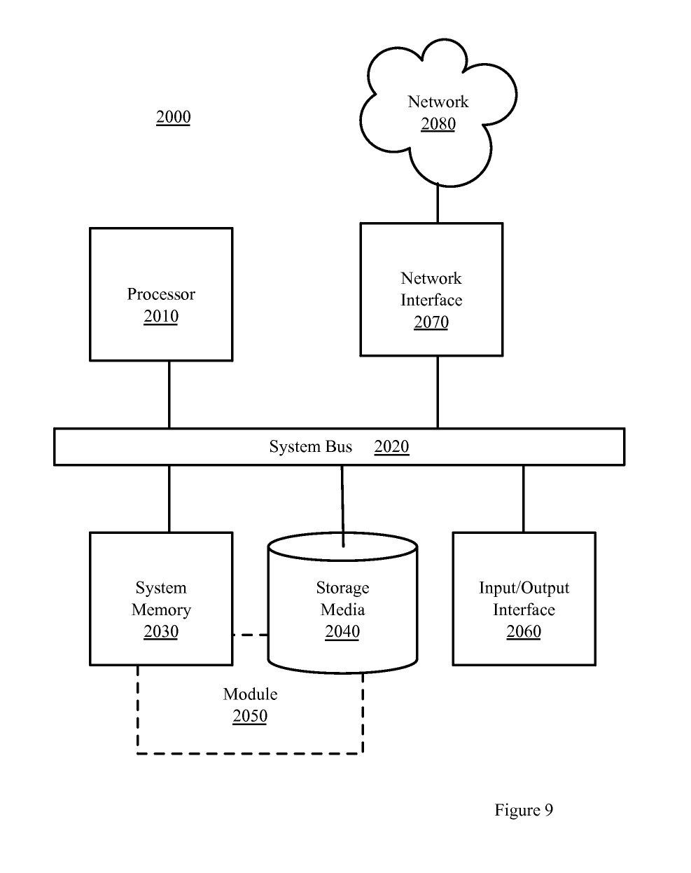

FIG. 9 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to present sets of organized images, comprising:
selecting, by one or more computing devices, a set of images, wherein the set of images comprises an image selected by a user via a user computing device and a plurality of images recommended in response to the selected image;
determining, by the one or more computing devices, a category for each image of the set of images by applying a shape-recognizing algorithm to each image of the set of images;
creating, by the one or more computing devices, a virtual presentation space;
dividing, by the one or more computing devices, the virtual presentation space into a plurality of sections;
placing, by the one or more computing devices, each image of the set of images within a separate section of the virtual presentation space;
repositioning, by the one or more computing devices, the sections comprising the images based at least in part on an application of one or more first categorical rules to the determined category for each image of the set of images, wherein the one or more first categorical rules are based on on the classification by the one or more computing devices of each image according to category;
resizing, by the one or more computing devices, at least one of the sections comprising the images based at least in part on an application of one or more second categorical rules, wherein the one or more second categorical rules are based on the classification by the one or more computing devices of each image according to category, and wherein resizing a particular section comprises resizing the particular section and the image within the particular section proportionally to each other;
detecting, by the one or more computing devices, leading edges of the images in the sections, wherein the leading edge is a principal linear edge of a particular image within a particular one of the sections;
identifying, by the one or more computing devices, two adjacent sections within the virtual presentation space, wherein one of the adjacent sections comprises an image that has a leading edge that is not parallel to the leading edge of the image within the other one of the adjacent sections;
rotating, by the one or more computing devices, at least one of the adjacent sections such that the leading edges of the images within the adjacent sections are parallel to each other to realign the adjacent sections;
rotating, by the one or more computing devices, the pair of adjacent sections based at least in part on one or more third categorical rules, wherein the one or more third categorical rules are based on the classification by the one or more computing devices of each image according to category, and wherein the pair of adjacent sections is rotated as one object; and
displaying, by the one or more computing devices, the virtual presentation space comprising the realigned adjacent sections.

2. The method of claim 1, wherein displaying the virtual presentation space comprising the realigned adjacent sections comprises communicating, by the one or more computing devices and to the user computing device, the virtual presentation space for display via the user computing device.

3. The method of claim 1, wherein the virtual presentation space is divided into a plurality of rectangular sections.

4. The method of claim 1, further comprising:
creating, by the one or more computing devices, one or more additional virtual presentation spaces;
for the virtual presentation space and for each of the one or more additional virtual presentation spaces, determining, by the one or more computing devices, a score for the positioning of the set of images based at least in part on the categorical rules;
comparing, by the one or more computing devices, the scores for the virtual presentation space and the one or more additional virtual presentation spaces;
selecting, by the one or more computing devices, one of the virtual presentation spaces having the best score; and
displaying, by the one or more computing devices, the selected one of the virtual presentation spaces.

5. The method of claim 1, wherein dividing the virtual presentation space into a plurality of sections and placing the images within the sections is conducted via a block recursive image composition algorithm.

6. The method of claim 1, further comprising, upon rotating the sections in each pair of adjacent sections such that the leading edges of the images within the adjacent sections are parallel to each other, occluding, by the one or more computing devices, any region of a section that occupies the same area in the virtual presentation space as a region of an image in a neighboring section.

7. The method of claim 1, wherein the image selected by the user via a user computing device is selected via a website.

8. The method of claim 1, wherein the categorical rules further comprise a rule to reduce space between images in the virtual presentation space.

9. The method of claim 1, further comprising, upon rotating the sections in each pair of adjacent sections such that the leading edges of the images within the adjacent sections are parallel to each other, moving, by the one or more computing devices, the pair of adjacent sections closer to each other until a configurable amount of space exists between the images within the sections.

10. A computer program product, comprising:
a non-transitory computer-readable medium having computer-readable program instructions embodied thereon that when executed by a computer cause the computer to present sets of organized images, the computer-readable program instructions comprising:
computer-readable program instructions to divide a virtual presentation space into a plurality of sections;
computer-readable program instructions to place each image of a set of images within a separate section of the virtual presentation space;
computer-readable program instructions to determine a category for each image of the set of images by applying a shape-recognizing algorithm to each image of the set of images;
computer-readable program instructions to reposition the sections comprising the images based at least in part on an application of one or more first categorical rules to the determined category for each image of the set of images, wherein the one or more first categorical rules are based on the classification of each image according to category;
computer-readable program instructions to detect leading edges of the images in the repositioned sections, wherein each leading edge is a principal linear edge of a particular image within a particular one of the repositioned sections;
computer-readable program instructions to identify two adjacent sections within the virtual presentation space, wherein one of the adjacent sections comprises an image that has a leading edge that is not parallel to the leading edge of the image within the other one of the adjacent sections;
computer-readable program instructions to rotate at least one of the adjacent sections such that the leading edges of the images within the adjacent sections are parallel to each other to realign the adjacent sections; and
computer-readable program instructions to display the virtual presentation space comprising the realigned adjacent sections.

11. The computer program product of claim 10, further comprising:
computer-readable program instructions to select a set of images to be displayed to the user, wherein the set of images comprises an image selected by the user via a user computing device and a plurality of images recommended in response to the selected image.

12. The computer program product of claim 10, further comprising:
computer-readable program instructions to reposition the sections comprising the images based at least in part on one or more second categorical rules, wherein the one or more second categorical rules are based on the classification of each image according to category; and
computer-readable program instructions to resize, at least one of the sections comprising the images based at least in part on the one or more second categorical rules, wherein resizing a particular section comprises resizing the particular section and the image within the particular section proportionally to each other.

13. The computer program product of claim 10, further comprising:
computer-readable program instructions to rotate the pair of adjacent sections based at least in part on one or more third categorical rules, wherein the one or more third categorical rules are based on the classification of each image according to category, and wherein the pair of adjacent sections is rotated as one object; and
computer-readable program instructions to determine a score for the positioning of the set of images based at least in part on the one or more first categorical rules and the one or more third categorical rules, wherein an image set presentation is created.

14. The computer program product of claim 13, further comprising:
computer-readable program instructions to create one or more additional virtual presentation spaces;
for the virtual presentation space and for each of the one or more additional virtual presentation spaces, computer-readable program instructions to determine a score for the positioning of the set of images based at least in part on the one or more first categorical rules and the one or more third categorical rules;
computer-readable program instructions to compare the scores for the virtual presentation space and for each of the one or more additional virtual presentation spaces;
computer-readable program instructions to select a particular one of the virtual presentation spaces having the best score; and
computer-readable program instructions to display the selected one of the virtual presentation spaces.

15. The computer program product of claim 14, wherein displaying the virtual presentation space comprising the realigned adjacent sections comprises communicating to the user computing device the virtual presentation space for display via the user computing device.

16. The computer program product of claim 10, further comprising, upon rotating the sections in each pair of neighboring sections such that the leading edges of the images within the neighboring sections are parallel to each other, computer-readable program instructions to occlude any region of a section that occupies the same area in the virtual presentation space as a region of an image in a neighboring section.

17. A system to present sets of organized images, comprising:
a storage device;
a user interface; and
a processor communicatively coupled to the storage device, wherein the processor executes application code instructions that are stored in the storage device to cause the system to:
divide a virtual presentation space into a plurality of sections;
place each image of a set of images within a separate section of the virtual presentation space, wherein each image of the set of images is classified according to category;
determine a category for each image of the set of images by applying a shape-recognizing algorithm to each image of the set of images;
reposition the sections comprising the images based at least in part on an application of one or more first categorical rules to the determined category for each image of the set of images, wherein the one or more first categorical rules are based on the classification of each image according to category;
detect leading edges of the images in the repositioned sections, wherein each leading edge is a principal linear edge of a particular image within a particular one of the repositioned sections;
identify two adjacent sections within the virtual presentation space, wherein one of the adjacent sections comprises an image that has a leading edge that is not parallel to the leading edge of the image within the other one of the adjacent sections;
rotate at least one of the adjacent sections such that the leading edges of the images within the adjacent sections are parallel to each other to realign the adjacent sections; and
display the virtual presentation space comprising the realigned adjacent sections via the user interface.

18. The system of claim 17, wherein the processor is further configured to execute computer-readable program instructions stored in the storage medium to cause the system to:
resize at least one of the sections comprising the images based at least in part on one or more second categorical rules, wherein the one or more second categorical rules are based on the classification by the one or more computing devices of each image according to category, and wherein resizing a particular section comprises resizing the particular section and the image within the particular section proportionally to each other.

19. The system of claim 17, wherein the processor is further configured to execute computer-readable program instructions stored in the storage medium to cause the system to:
create one or more additional virtual presentation spaces;
for the virtual presentation space and for each of the one or more additional virtual presentation spaces, determine a score for the positioning of the set of images based at least in part on the one or more first categorical rules;
compare the scores for the virtual presentation space and each of the one or more additional virtual presentation spaces; and
select a particular one of the virtual presentation spaces having the best score; and
display the selected one of the virtual presentation spaces.

20. A method for presenting a set of images, comprising:
creating, by the one or more computing devices, one or more virtual presentation spaces;
for each of the one or more virtual presentation spaces:
dividing, by the one or more computing devices, the virtual presentation space into a plurality of sections;
placing, by the one or more computing devices, each image of a set of images within a separate section of the virtual presentation space;
determining, by the one or more computing devices, a category for each image of the set of images by applying a shape-recognizing algorithm to each image of the set of images;
repositioning, by the one or more computing devices, the sections comprising the images based at least in part on one or more first categorical rules, wherein the one or more first categorical rules are based on the classification of each image according to category;
resizing, by the one or more computing devices, at least one of the sections comprising the images based at least in part on the one or more second categorical rules, wherein the one or more second categorical rules are based on the classification of each image according to category, and wherein resizing a particular section comprises resizing the particular section and the image within the particular section proportionally to each other;
detecting, by the one or more computing devices, leading edges of the images in the sections, wherein the leading edge is a principal linear edge of a particular image within a particular one of the sections;
identifying, by the one or more computing devices, two adjacent sections within the virtual presentation space, wherein one of the adjacent sections comprises an image that has a leading edge that is not parallel to the leading edge of the image within the other one of the adjacent sections;
rotating, by the one or more computing devices, at least one of the adjacent sections such that the leading edges of the images within the adjacent sections are parallel to each other to realign the adjacent sections;
rotating, by the one or more computing devices, the pair of adjacent sections based at least in part on one or more third categorical rules, wherein the one or more third categorical rules are based on the classification of each image according to category, and wherein the pair of adjacent sections is rotated as one object;
determining, by the one or more computing devices, a score for the positioning of the set of images based at least in part on the one or more first categorical rules, the one or more second categorical rules, and the one or more third categorical rules;
comparing, by the one or more computing devices, the score of the virtual presentation space to the scores of one or more other virtual presentation spaces created by the one or more computing devices;
selecting, by the one or more computing devices, a particular one of the one or more virtual presentation spaces having the best score; and
displaying, by the one or more computing devices, the selected one of the virtual presentation spaces, wherein displaying comprises communicating, by the one or more computing devices and to the user computing device, the selected virtual presentation space for display via the user computing device.
